(19) United States
(12) Patent Application Publication
(10) Pub. No.: US 2026/0233104 A1
(43) Pub. Date: Aug. 13, 2026

(54) AUTOMATIC GENERATION OF DIGITAL ASSETS FOR VIDEO GAMES

(71) Applicant: Sony Interactive Entertainment Inc., Tokyo (JP)

(72) Inventor: Isaiah Webb, San Mateo, CA (US)

(21) Appl. No.: 19/047,930

(22) Filed: Feb. 7, 2025

(51) Int. Cl. A63F 13/67; A63F 13/52

(52) U.S. Cl. CPC A63F 13/67; A63F 13/52

(57) ABSTRACT

Methods, systems, and apparatus, including computer programs encoded on a computer storage medium, for obtaining, by one or more processing devices, content criteria for digital assets representative of a video game; receiving a compressed software package including a plurality of files representing game elements associated with the video game; decompressing the software package to obtain the plurality of files representing the game elements the video game; emulating a gaming console to simulate game-play of the video game using the plurality of files, the game-play using at least a portion of the game elements represented in the plurality of files; generating, from the simulated game-play, one or more digital assets that satisfy the content criteria; and storing the one or more digital assets in a repository, wherein the one or more digital assets are configured to provide preview of the video game.

### TECHNICAL FIELD

This disclosure generally relates to digital content such as key art for video games.

### BACKGROUND

Video game content such as key art can include visually compelling images and/or videos that are used to promote a video game. Key art can include digital assets that capture the game's essence, story, and characters to attract and engage potential players. Key art can include art assets, such as textures, sprites, meshes, effects, and fonts, and can include sound assets, such as music and sound effects.

### SUMMARY

In some implementations, a content server generates content, including digital assets representative of a video game, and publishes the digital assets to a game catalog. Digital assets can include key art for the video game. The digital assets can be created by a computing system performing emulation of a gaming console to simulate game-play of the video game. The computing system can extract digital assets (e.g., images, videos, animation) from the simulated game-play of the video game. In some examples, the computing system can extract the digital assets by processing the simulation of game-play of the video game with a machine learning model that is trained to extract digital assets that satisfy content criteria. In some examples, the computing system can extract assets from the simulation of game-play of the video game, and can evaluate the extracted assets to determine whether the extracted assets satisfy the content criteria. In response to determining that the extracted assets satisfy the content criteria, the computing system can store the assets. In response to determining that the extracted assets do not satisfy the content criteria, the computing system can modify the assets, obtain new assets from the simulation of game-play of the video game, or both.

In some implementations, a content server receives digital assets contributed from other systems, tests and verifies the digital assets, and publishes the digital assets to the game catalog. The digital assets can be created by video game developers or by other users. The content server can verify each of the received digital assets by evaluating the digital assets using content criteria. In some implementations, validating the digital assets can include evaluating the digital assets using content criteria. If a digital asset fails to satisfy the content criteria, the cause of failure can be identified, the digital asset can be modified, and then the modified digital asset can be re-evaluated. In validating the digital asset, a machine learning network (e.g., a machine learning model such as a neural network) can be leveraged to recognize and/or generate digital assets that satisfy the content criteria. Upon verifying a digital asset, the content server can publish the digital asset, making it viewable by users of a video game catalog. The published digital assets provide users with preview of the video game.

Publishing a digital asset can include adding the digital asset to a listing or catalog of available digital assets and making the digital asset accessible to one or more servers. In some examples, publishing the digital asset can include sending the digital asset to a gaming platform for inclusion in the game catalog. The game catalog can be provided to users of the gaming platform. For example, a user can view, on a display of a computing device, a list of video game titles hosted by the gaming platform. Each video game title can be shown next to a thumbnail image that represents the video game. The thumbnail image is an example of a digital asset. When the user clicks on the game title or thumbnail image, the user can view additional digital assets that represent the video game, such as a logo, a cover image, images of video game characters, images of video game environments, video clips from the video game, or any combination of these.

In one general aspect, a method, performed by one or more processing devices, includes: obtaining, by one or more processing devices, content criteria for digital assets representative of a video game; receiving, by the one or more processing devices and over a network, a compressed software package including a plurality of files representing game elements associated with the video game; decompressing, by the one or more processing devices, the software package to obtain the plurality of files representing the game elements the video game; emulating, by the one or more processing devices, a gaming console to simulate game-play of the video game using the plurality of files, the game-play using at least a portion of the game elements represented in the plurality of files; generating, by the one or more processing devices and from the simulated game-play, one or more digital assets that satisfy the content criteria; and storing, by the one or more processing devices, the one or more digital assets in a repository. The one or more digital assets are configured to provide preview of the video game.

Implementations can include one or more of the following features. For example, in some implementations, generating the one or more digital assets includes: extracting an image from the simulated game-play of the video game; determining whether the image satisfies the content criteria; and in response to determining that the image satisfies the content criteria, storing the image as a digital asset of the one or more digital assets; or in response to determining that the image does not satisfy the content criteria: modifying the image such that the modified image satisfies the content criteria; and storing the modified image as a digital asset of the one or more digital assets.

In some implementations, the content criteria specifies a list of digital assets to be published for the video game, the method including iteratively generating digital assets until the stored one or more digital assets include every item on the list of digital assets.

In some implementations, the game elements include at least one of: textures, characters, sounds, objects, and models, for the video game.

In some implementations, the method further includes identifying the gaming console in accordance with a formatting of the compressed software package.

In some implementations, the method includes: configuring an emulator to emulate the gaming console; and using the configured emulator to simulate the game-play of the video game.

In some implementations, generating the one or more digital assets that satisfy the content criteria includes: processing the simulated game-play of the video game with a machine learning model that is trained to extract digital assets representative of video games; and evaluating the extracted digital assets using the content criteria.

In some implementations, the one or more digital assets each include one or more of: an image file, a video file, or a text file.

In some implementations, the method includes, after storing the one or more digital assets in the repository, sending, over the network, the one or more digital assets for review by an approving authority.

In some implementations, the method includes: receiving, over the network and from the approving authority, approval of a digital asset of the one or more digital assets; and publishing the digital asset to a digital video game catalog.

In some implementations, the method includes: receiving, from the approving authority, rejection of a digital asset of the one or more digital assets; modifying the digital asset; and sending, over the network, the modified digital asset for review by the approving authority.

In some implementations, modifying the digital asset includes changing one or more of: a size of the digital asset, a resolution of the digital asset, relative sizes of images included in the digital asset, a color of the digital asset, a layout of the digital asset, or a textual content of the digital asset.

In some implementations, a digital asset of the one or more digital assets includes an image and metadata describing the image, and storing the digital asset includes storing the digital asset in association with the metadata.

In some implementations, generating a digital asset of the one or more digital assets includes: extracting an image from the simulated game-play of the video game; generating a set of metadata describing the image; and determining whether the image satisfies the content criteria based at least in part on the generated set of metadata. Storing the digital asset includes storing the digital asset in association with the generated set of metadata.

In some implementations, generating a digital asset of the one or more digital assets includes: providing simulation data from the simulated game-play of the video game to a machine learning model that is trained to recognize digital assets that satisfy the content criteria; and obtaining the digital assets as output from the machine learning model.

Other implementations of any of the above aspects include corresponding systems, apparatus, and computer programs that are configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram illustrating an example system for generating and publishing digital assets for video games.

FIG. 2 is a flow chart of an example process for generating and publishing digital assets for video games.

FIG. 3 is a diagram illustrating an example system for validating, modifying, and publishing digital assets for video games.

FIG. 4 is a diagram illustrating an example system for digital content verification and modification.

FIG. 5 is a flow chart of an example process for validating, modifying, and publishing digital assets for video games.

FIG. 6 shows an example game catalog page for a video game.

FIG. 7 is a diagram illustrating an example system for approving modified content for publication.

FIG. 8 shows an example of a computing device and associated accessories that can be employed to execute implementations of the present disclosure.

Like reference numbers and designations in the various drawings indicate like elements.

### DETAILED DESCRIPTION

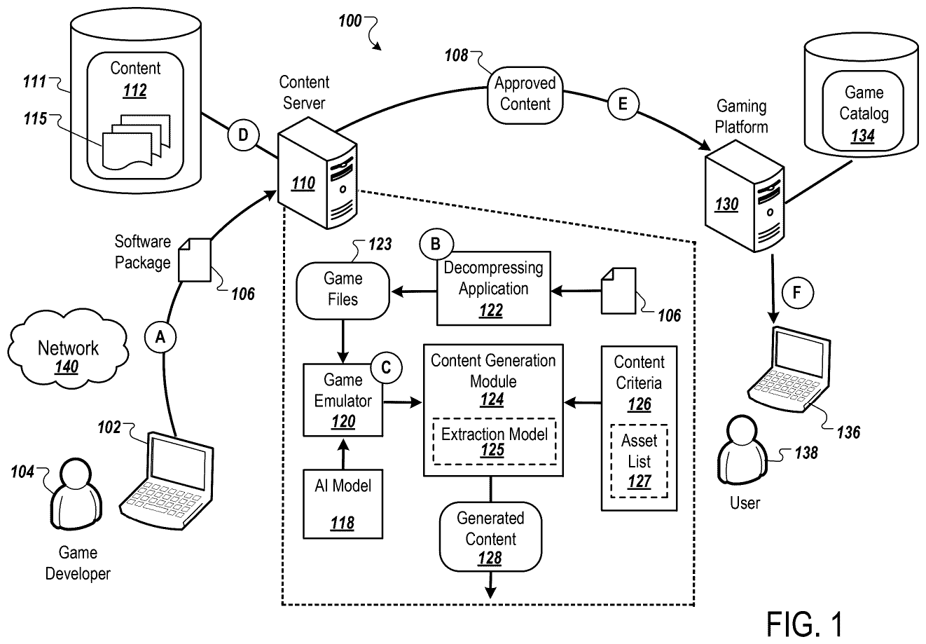

FIG. 1 is a diagram illustrating an example system 100 for generating and publishing digital assets for video games. A digital asset can be a content item, such as key art, for a video game. In some cases, the digital asset includes an image file, a video file, a sound file, a text file, or any combination of these.

The system 100 includes a content server 110 and a game developer device 102. The system 100 allows the content server 110 to push one or more digital assets to a gaming platform 130. The system 100 also allows the gaming platform 130 to pull one or more digital assets from the content server 110. The content server 110 can provide various different systems with a listing of digital assets that are available.

The game developer device 102 can be a computing device, such as a desktop computer, a laptop computer, a mobile phone, a smart phone, a personal digital assistant (PDA), a tablet computer, or other computing devices. The game developer device 102 can communicate with the content server 110 over, for example, the network 140.

A game developer 104 is a developer of a video game. The game developer 104 can create a compressed software package for a video game (e.g., software package 106) that is to be released by the gaming platform 130. The game developer 104 can upload the software package 106 to the content server 110 over the network 140. The network 140 can include public and/or private networks and can include the Internet. In some examples, the software package 106 is received by the content server 110 from an entity other than the game developer 104. For example, the software package 106 can be received from an owner or distributor of video games.

The content server 110 has associated data repository 111 storing one or more content libraries 112. The data repository 111 can be a data repository for digital assets. In some examples, the content library 112 includes multiple sets of files, where each set of files includes digital assets for a respective video game.

The content server 110 can include one or more computing devices. The content server 110 communicates with gaming platform 130 over the network 140. In some implementations, one or more processors of the content server 110 can communicate with the game developer device 102 and one or more other computers of the content server 110 can perform other tasks, such as communicating with the gaming platform 130. The content server 110 can communicate with the gaming platform 130 through one or more application programming interfaces (APIs).

The gaming platform 130 can include one or more computing devices. The gaming platform 130 can be remote with respect to the content server 110. The gaming platform 130 can be part of a cloud computing platform (e.g., Amazon Web Services (AWS), Microsoft Azure, and so on).

In the example of FIG. 1, the content server 110 provides approved content 108, including approved digital assets, for publication to a game catalog 134. The game catalog 134 A is a collection of video games that can be accessed and/or downloaded. In some examples, a video game catalog is managed by a digital media delivery service provider. In some examples, the digital media delivery service provider is an online multiplayer gaming service provider. The video game catalog can include video games that are available to stream or download from the digital media delivery service provider. In some examples, the video game catalog includes video games that are available to play on a particular gaming console. In some implementations, the content server 110 is operated by or is affiliated with the provider of the gaming platform 130. The digital assets can be created, tested, and/or verified before being made available to the gaming platform by the content server 110. The content server 110 can evaluate the digital assets using content criteria established by the digital media delivery service provider.

The techniques disclosed in this document can increase the efficiency and accuracy of generating and publishing key art for video games. One or more digital assets can be accessed, modified, approved, and published in order to automate many tasks that would otherwise require significant manual input. In addition, by reducing the amount of manual input needed, key art publishing using the disclosed techniques is less prone to errors and inconsistencies in standards. The disclosed techniques further improve the efficiency and accuracy of game art publishing by allowing the customization of digital assets to the specific needs of a particular console, platform, system, or machine. In addition, by performing verification testing on the digital assets prior to publishing, the system reduces the likelihood that those digital assets will need to later be modified by a server system and/or reduces the extent of modification that will be needed.

FIG. 1 illustrates a flow of data, shown as stages (A) to (F), with each representing a step in an example process. Stages (A) to (F) can occur in the illustrated sequence, or in a sequence that is different from the illustrated sequence. For example, some of the stages can occur concurrently.

As shown in FIG. 1, in stage (A), the game developer device 102 uploads a game software package 106 to the content server 110 over the network 140. The game software package 106 can be created on the game developer device 102 or any of various other devices and uploaded to the content server 110.

The game software package 106 includes files representing game elements associated with a video game (e.g., “game files 123”). The software package 106 can be, for example, a .PAK file, .PKG file, .PKGS file, .PACKAGE file, .FBX file, or another type of software package. The elements associated with the video game include, for example, textures, character information, sounds, models, and other game data for the video game.

The game developer device 102 can upload, with the software package 106, metadata for the video game. The metadata can include, for example, a game title, game description, genre, gaming console compatibility, number of players supported, age rating, and/or other textual information about the video game.

In some examples, the game files 123 are formatted for operation by a particular gaming console. Example gaming consoles include, for example, PlayStation consoles, Nintendo consoles, and Xbox consoles. Game consoles can be, for example, home consoles (e.g., Xbox Series X, PlayStation 5), handheld consoles (e.g., Nintendo Switch, Steam Deck, PlayStation Portal), or personal computers (PCs).

In some examples, the content server 110 can identify the particular gaming console or gaming consoles for which the game files 123 are formatted. For example, the content server 110 can determine whether the game files 123 are compatible with a particular brand of gaming consoles (e.g., PlayStation consoles). The content server 110 can determine whether the game files 123 are compatible with a particular model or models of a console (e.g., PlayStation 4, PlayStation 5). In some cases, the content server 110 can identify the particular gaming console using the metadata for the game software package 106. In some examples, the content server 110 can identify the particular gaming console by analyzing the file types of the game files 123 after decompressing the software package 106.

In stage (B), the content server 110 uses a decompressing application 122 to decompress the software package 106 to obtain the game files 123 for the video game. The decompressing application 122 can decompress the software package 106, for example, using compression software. The game files 123 represent game elements associated with the video game.

In stage (C), the content server 110 generates digital assets 115 by simulating game-play of the video game. The digital assets 115 are configured to provide preview of the video game. For example, the digital assets 115 can include key art for the video game. The digital assets can include images, video, text, and/or sound that is representative of the video game.

To generate the digital asset 115, the content server 110 can access a game emulator 120. An emulator interprets the operating system (OS) and software of the gaming console being emulated. Emulators can also emulate other hardware, such as input and output devices. An emulator allows a computing device, such as the content server 110, to emulate a gaming console's hardware and play its games on the emulating platform. In some examples, the content server 110 uses an artificial intelligence (AI) model 118 to play the video game using the emulator. The AI model 118 can be trained to play one or more specific types of games (e.g., open-world games, puzzles games, role-playing games, sandbox games, simulation games, sports games, etc.)

The game emulator 120 can be hosted by the content server 110 or by another computing system. The game emulator 120 simulates game-play of the video game using the game elements represented in the game files 123.

In some examples, the game emulator 120 is configured to imitate the particular gaming console that is compatible with the game files 123. In some examples, the content server 110 configures the emulator 120 in accordance with a formatting of the compressed software package. The content server 110 can configure the emulator 120 to imitate the gaming console, and use the configured emulator to emulate the gaming console in order to simulate game-play of the video game.

In some examples, the content server 110 has access to multiple different game emulators for multiple different gaming consoles. The content server 110 can select the emulator that is configured to emulate the particular gaming console that is compatible with the video game.

In some examples, the video game is compatible with multiple different gaming consoles, and the content server 110 selects a particular gaming console for the game emulator 120 to emulate. The content server 110 can select the particular gaming console, for example, based on a recency of release of the gaming console. For example, a video game may be compatible with a PlayStation 4 and with a PlayStation 5. The content server 110 can select to simulate play of the video game using a game emulator 120 that is configured to imitate the PlayStation 5, which is a more recently-released gaming platform compared to the PlayStation 4.

The content server 110 includes a content generation module 124. The content generation module 124 uses the simulation of game-play of the video game to generate content 128 that satisfies content criteria 126.

The content criteria 126 includes criteria for digital assets that are to be published in the game catalog 134. In some examples, the content criteria 126 specifies a list of digital assets to be published for the video game (e.g., asset list 127). The asset list 127 can include, for example, a list of images (e.g., an image of a main character, an image of a secondary character, an image of an environment), a list of videos (e.g., a video of an action sequence, a video of a dialog between two characters), a list of sounds (e.g., a music theme, a voice of a main character), or any combination of these.

In some examples, the content criteria specifies, for each item on the list of digital assets, one or more characteristics. For a digital asset that is an image, the characteristics can include a size, a resolution, a color scheme, a shape, a layout, and/or other characteristics of the image. For a digital asset that is a video, the characteristics can include a duration, a size, a resolution, a frame rate, and/or other characteristics of the video. For a digital asset that is a sound, the characteristics can include a duration, a frequency range, a volume, and/or other characteristics of the sound.

The content criteria 126 can be obtained by the content server 110, for example, by an administrator of the gaming platform. In some examples, the content criteria can be automatically generated. For example, the content server 110 can employ one or more machine learning models that are trained to generate content criteria from training examples of digital assets that are labeled as satisfactory. In some examples, the machine learning models are trained to generate content criteria using example digital assets obtained from the game catalog 134.

Machine learning is a branch of artificial intelligence that involves the use and development of computing devices and/or systems that are able to learn and adapt without following explicit instructions, by using algorithms and statistical models to analyze and draw inferences from patterns in data. There are various classes of machine learning techniques including regression techniques, clustering techniques, tree-based methods, and neural networks, which can be applied to the paradigms of supervised, unsupervised, and reinforcement learning. Within each of these classes, there can be various types of machine learning models (e.g., diffusion models, flow models, demasking models, encoder-decoder transformer models, decoder transformer models, etc.), which are characterized by distinct model architectures that can influence the performance of the machine learning models. In general, the “architecture” of a machine learning model refers to the structure and organization of the components and processes that are part of the machine learning model. In so-called “generative” applications, machine learning models can be used to generate text, image, and other content based on the data on which they were trained.

The content criteria 126 can vary for different types (e.g., genres) of games. For example, the content criteria 126, including the asset list 127, may be different for a puzzle game than for an open world game. The content criteria 126 can vary for different stages of game deployment. For example, the content criteria 126, including the asset list 127, may be different for a game that is in a pre-order stage than for a game that has already been released. The content criteria 126 can vary for different gaming platforms and/or different game consoles that are compatible with the video game.

In some examples, the content generation module 124 uses a machine learning model such as extraction model 125 to extract digital assets from the simulated game-play of the video game. For example, the extraction model 125 can be trained to identify images within the simulated game-play of the video game that satisfy the content criteria 126. In some examples, the extraction model 125 is trained to identify video segments within the simulated game-play of the video game that satisfy the content criteria 126. In some examples, the extraction model 125 is trained to identify sounds within the simulated game-play of the video game that satisfy the content criteria 126. In some examples, the extraction model 125 is trained to identify a set of digital assets (e.g., including images, video, sounds, or any combination of these) within the simulated game-play of the video game that satisfy the content criteria 126.

The extraction model 125 can be trained using example content that has been labeled as satisfactory. For example, the extraction model 125 can be trained with training samples obtained from the game catalog 134. The training samples can include images, video, sounds, text, etc. that have been published in the game catalog 134 and are therefore known to be examples of approved content. The extraction model 125 can thus be trained to extract content from the simulated game-play of the video game that satisfies the content criteria 126 or is likely to satisfy the content criteria 126.

The content generation module 124 can process the simulated game-play of the video game using the machine learning model(s), and obtain the identified digital assets as output from the machine learning model. The input to the machine learning model(s) can include simulation data from the simulation of the game-play of the video game. The simulation data can include, for example, video, imagery, text, and/or sound from the simulation of game-play of the video game.

In some examples, the content generation module 124 extracts content (e.g., digital assets such as images, video, sounds) from the game emulator 120 and evaluates the content using the content criteria 126. In response to determining that a digital asset satisfies the content criteria 126, the content generation module 124 outputs the digital asset as generated content 128 to be stored in the content library 112.

In some examples, the content generation module 124 generates a set of metadata describing the digital asset. The metadata can specify properties of the digital asset such as file type, file size, image dimensions, image resolution, video length, and/or other properties. In some cases, the metadata can include alternative text that describes the composition of a digital asset. For example, the metadata for an image can include alternative text that describes the composition of the image (e.g., “a gray-haired, bearded man in armor with a sword on his back stands against a snowy mountain backdrop”). Similarly, the metadata for a video can include alternative text that describes the composition of the video, such as text that describes the characters shown in the video and the actions that the characters are taking in the video.

In some cases, the content server 110 can determine whether the digital asset satisfies the content criteria based at least in part on the generated set of metadata. For example, the metadata can specify properties of the digital asset, and the content criteria 126 can include requirements for the properties. The content server 110 can therefore determine whether the digital asset satisfies the content criteria by comparing the properties specified by the metadata with the requirements for the properties. The metadata can be stored in the content library 112 in association with the generated digital asset.

In response to determining that a digital asset does not satisfy the content criteria 126, the content generation module 124 can modify the digital asset such that the modified digital asset satisfies the content criteria 126. The content server 110 can output the modified digital asset as generated content 128 to be stored in the content library 112. In some examples, the generated content 128 includes multiple digital assets 115 that are output by the content generation module 124 at the same time, or approximately the same time. The multiple digital assets 115 may be generated from the same instance of simulation of game-play of the video game. In some examples, the generated content 128 output by the content generation module 124 includes a single digital asset 115. In some cases, the content server 110 can repeat the process of generating content from the simulation of game-play of the video game until all digital assets on the asset list 127 have been generated.

In stage (D), the content server 110 adds the generated content 128, including newly generated digital assets 115, to the content library 112, which is stored in the data repository 111. The digital assets 115 can include some or all of the assets specified in the asset list 127.

The content library 112 can include content for multiple video games. In some examples, the content library 112 includes content for multiple different gaming platforms.

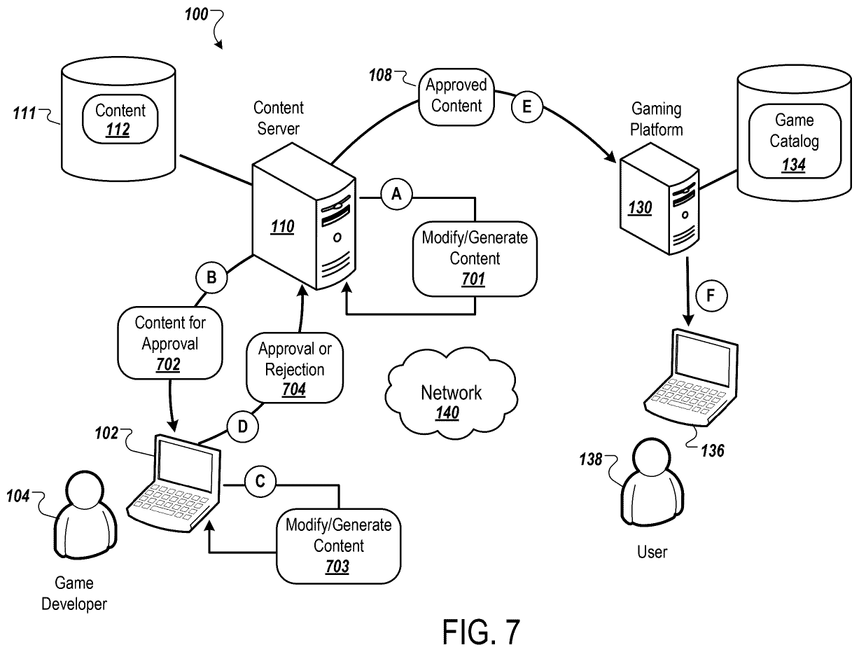

The content library 112 can include content in various stages of verification and approval. In some examples, each digital asset 115 in the content library 112 is assigned a current approval status. For example, the status can indicate that a digital asset satisfies the content criteria 126 but has not yet been approved by the game developer 104. In another example, the status can indicate that the digital asset satisfies the content criteria 126 and has been approved by the game developer 104 but has not yet been approved for release to the game catalog 134. Approval of digital assets by the game developer is described in greater detail with reference to FIG. 7.

When a digital asset or set of digital assets (e.g., a set of digital assets for a particular video game) are approved for publishing, the digital assets can be considered approved content 108.

In stage (E), the content server 110 sends approved content 108 to the gaming platform 130. The approved content 108 can be sent by the content server 110 to the gaming platform 130 over the network 140. The content server 110 can push the approved content 108 if they have been recently updated (e.g., new digital assets have been added, digital assets have been modified, etc.). The content server 110 can push the approved content 108 periodically. For example, the content server 110 can have scheduled to send the gaming platform 130 approved content every two days.

In some cases, the content server 110 pushes the approved content 108 on demand, such as in response to receiving input from the game developer 104 or an administrator of the content server 110 or the gaming platform 130. In some cases, the content server 110 pushes the approved content 108 according to a schedule. As an example, a video game may be scheduled to launch at a designated date and time. At the designated date and time, the content server 110 can send the approved content 108 for the video game to the gaming platform 130 for incorporation into the game catalog 134.

In stage (F), after the gaming platform 130 receives the approved content 108, a user 138 of the client device 136 can view digital assets in the game catalog 134. In some examples, the user 138 can interact with digital assets in the game catalog 134. For example, the user 138 can view videos and listen to sounds that have been published in the game catalog.

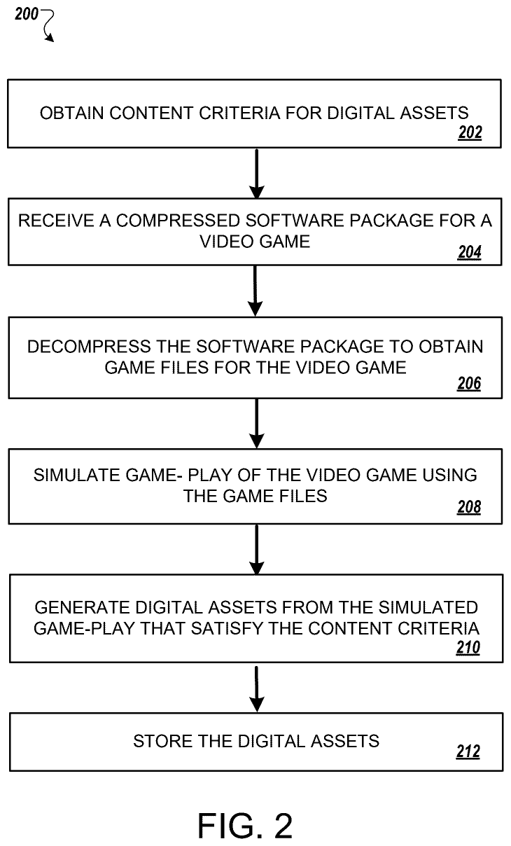

FIG. 2 is a flow chart of an example process 200 for generating and publishing digital assets for video games. The process 200 can be performed, at least in part, using the system 100 described herein. In some examples, the steps of the process 200 can be performed by a computing system such as the content server 110. In some examples, the steps of the process 200 can be performed by multiple computing systems. For example, some steps of the process 200 can be performed by the content server 110, and other steps of the process 200 can be performed by the gaming platform 130.

The process 200 includes obtaining content criteria for digital assets (202). For example, referring to FIG. 1, the content server 110 obtains the content criteria 126, which can include the asset list 127.

The process 200 includes receiving a compressed software package for a video game (204). For example, referring to FIG. 1, the content server 110 receives the game software package 106 from the game developer device 102. The compressed software package 106 can include multiple files representing game elements associated with the video game (e.g., the game files 123).

The process 200 includes decompressing the software package to obtain game files for the video game (206). For example, referring to FIG. 1, the decompressing application 122 decompresses the software package 106 to obtain the game files 123.

The process 200 includes simulating game-play of the video game using the game files (208). For example, referring to FIG. 1, the game emulator 120 simulates game-play of the video game using at least a portion of the game elements represented in the game files 123.

The process 200 includes generating digital assets from the simulated game-play that satisfy the content criteria (210). For example, referring to FIG. 1, the content generation module 124 generates content 128 including digital assets 115 that satisfy the content criteria 126.

The process 200 includes storing the digital assets (212). For example, referring to FIG. 1, the content server 110 stores the digital assets 115 in the data repository 111. The digital assets 115 are configured to provide preview of the video game.

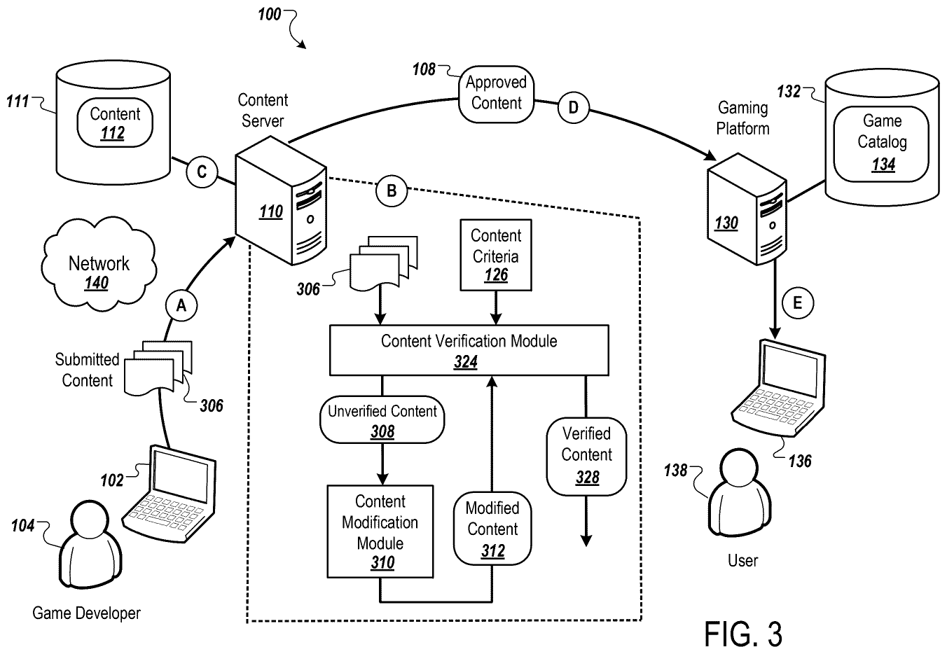

FIG. 3 is a diagram illustrating the example system 100 performing verification and publishing of digital assets. The system 100 includes the content server 110 having the data repository 111. The system 100 is able to receive submitted content 306 which can include digital assets from various systems over the network 140. The system 100 can modify the one or more digital assets. The system 100 can publish the one or more modified digital assets, making the one or more modified digital assets available to other systems.

The content server 110 can perform verification testing on the submitted content. Upon verification of a digital asset, the content server 110 can store the digital asset in the data repository 111. The data repository 111 can be memory, such as non-volatile memory. The content server 110 can publish the digital asset by providing the approved content 108 to the gaming platform 130.

FIG. 3 illustrates a flow of data, shown as stages (A) to (E), with each representing a step in an example process. Stages (A) to (E) can occur in the illustrated sequence, or in a sequence that is different from the illustrated sequence. For example, some of the stages can occur concurrently.

As shown in FIG. 3, in stage (A), a process for performing verification and publishing of digital assets starts with the game developer 104 or another user providing submitted content 306 which can include one or more digital assets. The game developer 104 can indicate that the submitted content 306 is meant to be published. Once the game developer 104 has indicated that the submitted content 306 is meant to be published, the submitted content 306 is sent from the game developer device 102 to the content server 110. In some implementations, the game developer 104 can save the submitted content 306 to the content server 110 and later indicate that the submitted content 306 should be published.

In some implementations, the game developer 104 generates metadata for the submitted content 306. The metadata can specify properties of the digital asset such as file type, file size, image dimensions, image resolution, video length, and/or other properties. In some cases, the metadata can include alternative text that describes the composition of a digital asset. For example, the metadata for an image can include alternative text that describes the composition of the image, and the metadata for a video can include alternative text that describes the composition of the video. The metadata can also include information about the video game such as a game title, game description, genre, gaming console compatibility, number of players supported, age rating, and/or other textual information about the video game. The metadata can be submitted to the content server 110 along with the submitted content 306.

In stage (B), upon receiving the submitted content 306, the content server 110 initiates verification testing on the submitted content 306 to determine whether the submitted content 306 satisfies the content criteria 126. The content server 110 includes a content verification module 324 and a content modification module 310. The content server 110 provides the submitted content 306 as input to the content verification module 324. The content verification module 324 can evaluate the submitted content 306 to determine whether the submitted content 306 satisfies the content criteria 126.

As described above with reference to FIG. 1, the content criteria 126 can specify a list of digital assets (e.g., asset list 127) to be published for the video game. The content verification module 324 can determine whether the submitted content 306 satisfies the content criteria 126 by determining whether the submitted content 306 includes at least every item on the asset list 127, or at least a minimum threshold number or percentage of items on the asset list 127.

As an example, the content criteria 126 may specify that the submitted content 306 should include the following list of digital assets: a square-shaped image, a rectangle-shaped image, a circle-shaped image, a video of five second duration with no sound, and a video of twenty second duration with accompanying sound.

The content criteria 126 can specify requirements for characteristics of digital assets. The characteristics can include, for example, a size, a resolution, a color scheme, a shape, a layout, a composition, a duration, a frame rate, a frequency range, a volume, and/or other characteristics of digital assets. For example, the content criteria 126 may specify ranges range of acceptable dimensions of the images, such as pixel length and width requirements for each of the images. In another example, the content criteria 126 specifies content and/or layout characteristics for images, such as requiring a square image showing the main character, where the main character occupies no more than 50% of the image. Another example requirement is a circular image showing a logo for the video game, where the logo occupies at least 60% of the image. Another example requirement is a rectangular image showing a main character, a logo, and a title for the video game, where the main character is on the right side and the logo and title are on the left side. Another example requirement is a ten second video clip showing the main character, a secondary character, and a scenic environment from within the video game.

The content criteria 126 can include criteria specific to different types and stages of video games. For example, the content criteria 126 can include genre-specific criteria 420, stage-specific criteria 422, console-specific criteria 424, gaming platform-specific criteria 426, other types of criteria, or any combination of these.

The content criteria 126 can vary for different types (e.g., genres) of games. For example, the content criteria 126, including the asset list 127, may be different for a racing game than for a sports game. The content criteria 126 can vary for different stages of game deployment. For example, the content criteria 126, including the asset list 127, may be different for a game that is being launched than for a game that is in pre-order. The content criteria 126 can vary for different gaming platforms and/or different game consoles that are compatible with the video game.

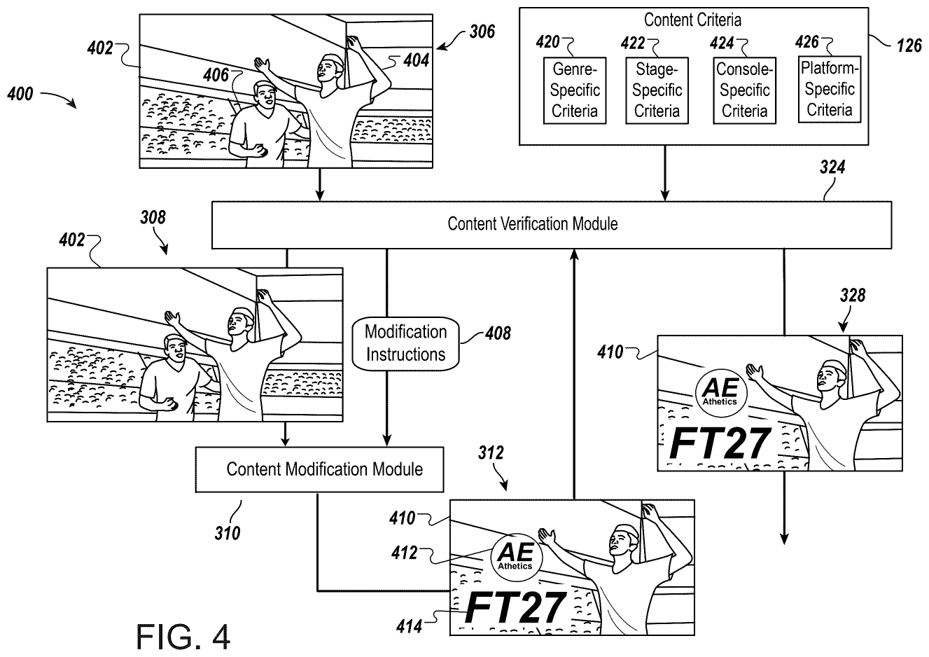

FIG. 4 illustrates an example modification process 400 for an example digital asset. In the example of FIG. 4, the submitted content 306 includes an image 402 of from a sports-related video game. The image 402 shows a main character 404 and a secondary character 406. The image 402 can be part of a group of digital assets uploaded to the content server 110 as submitted content 306, or can be an individual digital asset uploaded to the content server 110 as submitted content 306.

The content verification module 324 evaluates the image 402 to determine whether the image 402 satisfies the content criteria 126. In some examples, the content verification module 324 includes one or more machine learning models that is trained to recognize content that satisfies the content criteria. The machine learning model(s) can be trained using example digital assets that satisfy the content criteria.

In some examples, the content verification module 324 includes multiple different machine learning models for multiple different types of digital assets. For example, the content verification module 324 can include a first machine learning model that is trained to recognize square images that satisfy content criteria for square images, and can include a second machine learning model that is trained to recognize short video clips (e.g., video clips of ten seconds or less) that satisfy the content criteria for short video clips. The content verification module 324 can evaluate a digital asset by selecting an appropriate machine learning model for the type of digital asset, and providing the digital asset as input to the selected machine learning model. The content verification module 324 can obtain, as output from the selected machine learning model, an indication of whether the digital asset satisfies the content criteria. In some examples, the output of the selected machine learning model includes a list of criteria that are not satisfied.

In some examples, the content verification module 324 includes multiple different machine learning models for multiple different categories of video games. The categories can include genres of video games (e.g., fantasy, adventure, sports, puzzle, racing, etc.). The categories can include the gaming console or gaming console type that the game is compatible with (e.g., handheld consoles, home consoles). The categories can include the stage of deployment of the video game (e.g., pre-order, launch, re-release). The content verification module 324 can evaluate a digital asset by selecting an appropriate machine learning model, or appropriate machine learning models for the category of the video game, and providing the digital asset as input to the selected machine learning model(s).

In some examples, the content verification module 324 determines that the submitted content 306 satisfies the content criteria 126. The submitted content 306 can then be designated as verified content 328 and can be output by the content server 110 for storage in the content library 112.

In some examples, the content verification module 324 determines that the submitted content 306 does not satisfy the content criteria 126, and designates the submitted content 306 as unverified content 308. The content verification module 324 outputs the unverified content 308 to the content modification module 310.

Referring to FIG. 4, the content verification module 324 determines that the image 402 does not satisfy the content criteria 126. The content verification module 324 outputs the image 402 as unverified content 308 to the content modification module 310. In some examples, the content verification module 324 outputs modification instructions 408 to the content modification module 310. The content modification instructions 408 can include, for example, a list of content criteria requirements that the unverified content 308 does not satisfy. For example, the content modification instructions 408 can indicate that the image 402 does not satisfy the content criteria 126 because the image is too large, the ratio of length to height is too great, the image includes a secondary character, the image does not include a game title, the image does not include a game logo.

The content modification module 310 modifies the unverified content 308 to generate modified content 312. In some examples, the content modification module 310 includes one or more machine learning models that are trained to modify unverified content 308 to meet content criteria. The content modification module 310 can provide the unverified content 308 as input to the machine learning model(s). The content modification module 310 can obtain, as output from the machine learning model(s), the modified content 312.

In the example of FIG. 4, the content modification module 310 outputs an image 410 as modified content 312. The image 410 is smaller than the image 402. The image 410 shows only the main character 404, and omits the secondary character 406. The image 410 has a smaller length-to-width ratio than the image 402. The image 410 includes a logo 412 and title 414.

In some examples, the content modification module 310 generates the modified content 312 using two or more digital assets from the submitted content 306. In an example, the submitted content 306 includes digital assets such as: an image of a main character, an image of a game logo, and an image or text of the game title. The content criteria 126 includes an asset list 127 that includes a single rectangular image that shows the main character, the game logo, and the game title, with the main character occupying between 30% and 50% of the image. The content modification module 310 can combine the digital assets to form a new digital asset that is a single image showing the main character, the game logo, and the game title, in the layout and/or proportion specified by the content criteria 126. In this way, the content modification module can use the submitted content 306 to generate new digital assets in order to obtain the digital assets specified by the asset list 127.

In some examples, the content modification module 310 performs all of the above modifications to the image 402 (e.g., changing the dimensions, removing the secondary character 406) in one step. In some examples, the content modification module 310 receives a first modification instruction 408, performs a first modification to the image 402 according to the first modification instruction, outputs the modified image 410 to the content verification module 324, receives a second modification instruction 408, performs a second modification to the image 402 according to the second modification instruction, outputs the modified image 410 to the content verification module 324, and repeats the process until no additional modification instructions 408 are received.

After the content modification module 310 generates the modified content 312, the content verification module 324 can evaluate the modified content 312 to determine whether the modified content 312 satisfies the content criteria 126. In response to determining that the modified content 312 satisfies the content criteria 126, the content verification module 324 can designate the modified content as verified content 328. In response to determining that the modified content 312 does not satisfy the content criteria 126, the modified content 312 can be designated as unverified content 308 and output to the content modification module 310 for additional modification. The content verification module can output new modification instructions 408 to the content modification module 310 that specify the additional modifications that are to be performed on the unverified content 308.

The content server 110 can modify the submitted content 306 repeatedly until the modified content 312 meets the content criteria 126 and is designated as verified content 328. These modifications can be automated. If the content server 110 makes an automatic modification to the submitted content 306, the verification testing to the submitted content 306 can be restarted or resumed with the modified version of the submitted content 306. The submitted content 306 can be evaluated and modified a number of times until various conditions are met such that the submitted content 306 satisfies all of the criteria and is designated as verified content 328. In the example of FIG. 4, the content verification module 324 determines that the image 410 satisfies the content criteria 126 and therefore outputs the image 410 as verified content 328.

During verification, metadata can be generated for the submitted content 306. In some examples, this metadata can be provided by the content server 110 itself. In some implementations, the metadata generated can be in addition to metadata that was received from the content server 110. For example, the content server 110 can have received metadata including information about a digital asset from a third-party server and can have received input from an administrator indicating a categorization for the digital asset. In this example, the content server 110 can combine both input in order to generate metadata for the digital asset. In these implementations, the combination of the generated metadata and the received metadata can form the metadata outputted by the content modification module 310.

In some implementations, the metadata generated replaces all or part of received metadata. For example, the content server 110 can have received metadata including a information about a digital asset from a third-party server but later received a different information from an administrator. In this example, in generating the metadata for the digital asset, the content server 110 can overwrite the information from the third-party server with the information provided by the administrator.

In stage (C), once a digital asset or group of digital assets has passed the evaluation performed by the content verification module 324, the content verification module 324 can output the verified content 328 and the metadata associated with the verified content 328. Upon the verified content 328 passing the verification testing, the content server 110 adds the verified content 328 and any associated metadata to the content library 112. In some examples, the verified content 328 is stored along with metadata indicating that the verified content 328 has been verified using the content criteria 126. The data repository 111 can be local storage with respect to the content server 110, such as a local database or local file server, or can be remote, such as a remote database, file server, or cloud storage.

In some examples, the verified content 328 output by the content verification module 324 is sent by the content server 110 for approval by an approving authority (e.g., the game developer 104). Approval of digital assets by the approving authority is described in greater detail with reference to FIG. 7.

When a digital asset or set of digital assets (e.g., a set of digital assets for a particular video game) are approved for publishing by the game developer 104, the digital assets can be designated as approved content 108. The approved content 108 therefore includes digital assets stored in the content library 112 that have been verified by the content verification module 324 and approved for publishing by the game developer 104.

In stage (D), the content server 110 pushes approved content 108 to one or more computer systems, such as the gaming platform 130. For example, the content server 110 can make the digital assets that are designated as approved content 108 available to the gaming platform 130 for inclusion in the game catalog 134.

At stage (E), after the gaming platform 130 receives the approved content 108, a user 138 of the client device 136 can view and interact with the approved content 108 in the game catalog 134.

In some cases, if it is determined that a digital asset does not satisfy one or more of the at least one predetermined criteria, a notification can be sent to the computer system that provided the digital asset. For example, with respect to FIG. 3 the content server 110 can generate and send a notification to the game developer device 102 that indicates the reasons why the submitted content 306 cannot be published, and/or a request for corrected submitted content.

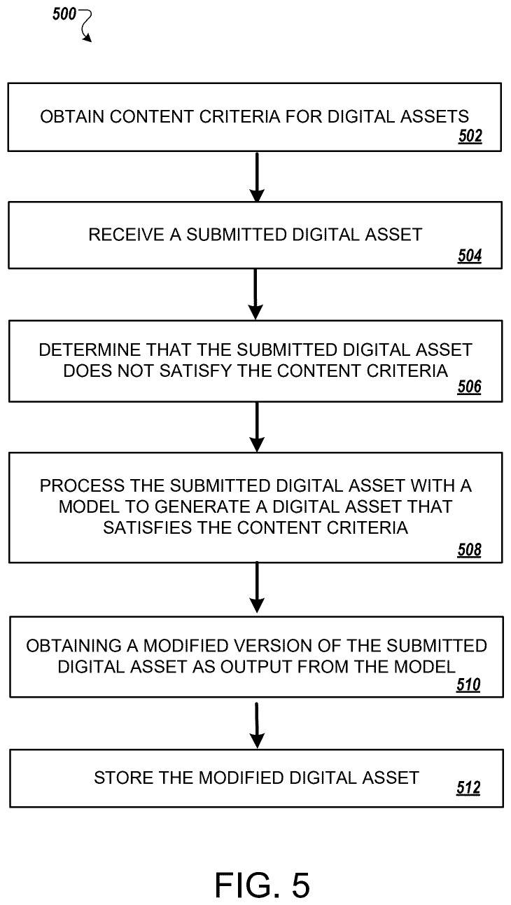

FIG. 5 is a flow chart of an example process 500 for validating, modifying, and publishing digital assets for video games.

The process 500 includes obtaining content criteria for digital assets (502). For example, referring to FIGS. 3 and 4, the content server 110 obtains the content criteria 126, which can include genre-specific criteria 420, stage-specific criteria 422, console-specific criteria 424, gaming platform-specific criteria 426, or any combination of these. Other types of criteria can include criteria specific to different video game developers, criteria specific to different video game franchises, and other types of criteria.

The process 500 includes receiving a submitted digital asset (504). For example, referring to FIG. 3, the content server 110 receives submitted content 306 from the game developer device 102. The submitted content 306 can include one or more digital assets.

The process 500 includes determining that the submitted digital asset does not satisfy the content criteria (506). For example, referring to FIG. 3, the content verification module 324 determines whether the submitted content 306 satisfies the content criteria 126.

The process 500 includes processing the submitted digital asset with a model to generate a digital asset that satisfies the content criteria (508). For example, referring to FIG. 3, the content server 110 processes the unverified content 308 with the content modification module 310 to generate modified content 312 that satisfies the content criteria 126. In some examples, the content modification module employs a model such as a machine learning model that has been trained to generate digital assets that satisfy the content criteria. In some cases, the content modification module 310 selects one or more machine learning models from a set of machine learning models for processing the unverified content 308. An individual machine learning model can be trained to generate digital assets of a particular type (e.g., images, videos, sounds). In some cases, an individual machine learning model is trained to generate digital assets that satisfy a particular set of criteria (e.g., criteria for a specific video game genre, criteria for a specific stage of video game release).

The process 500 includes obtaining a modified version of the submitted digital asset as output from the model (510). For example, referring to FIG. 3, the content server 110 obtains the modified content 312 as output from the content modification module 310. The content verification module 324 can evaluate the modified content 312 to determine whether the modified content 312 satisfies the content criteria 126.

In some examples, the content modification module 310 outputs the modified content 312 directly to the content library 112. For example, when the content modification module 310 employs machine learning model(s) that are trained to generate digital assets that satisfy the content criteria 126, the modified content 312 can be designated as verified content 328 and might not undergo additional verification by the content verification module 324.

The process 500 includes storing the modified digital asset (512). For example, referring to FIG. 3, the content server 110 stores the modified content 312, designated as verified content 328, in the content library 112. The digital assets designated as verified content 328 are configured to provide preview of the video game.

In some examples, the content server 110 generates a set of metadata describing the digital assets that are designated as verified content 328. The metadata can specify properties of the digital asset such as file type, file size, image dimensions, image resolution, video length, and/or other properties. In some cases, the metadata can include alternative text that describes the composition of a digital asset. For example, the metadata for an image can include alternative text that describes the composition of the image, and the metadata for a video can include alternative text that describes the composition of the video. The metadata can be stored with the verified content 328 in the content library 112.

Although process 200 and process 500 are described as separate processes, steps of the processes 200 and 500 by the system 100 can overlap and/or be performed simultaneously. For example, the content server 110 can receive both a compressed software package for a video game (e.g., software package 106) and submitted digital assets for the video game (e.g., submitted content 306). The content server 110 thus performs both step 204 of process 200 (receive a compressed software package for a video game) and step 504 of process 500 (receive a submitted digital asset) at the same time or approximately the same time.

When the content server 110 receives both the software package 106 and the submitted content 306, the content server 110 can evaluate both received items simultaneously or sequentially. In some examples, the content server 110 evaluates the received items sequentially by first evaluating the submitted content 306 using the process 500 as illustrated in FIG. 3, and then generating new content 128 using the process 200 as illustrated in FIG. 1. For example, referring to FIG. 3, the content server 110 can evaluate the submitted content 306 using the content verification module 324 to identify assets within the submitted content 306 that satisfy the content criteria 126 and can therefore be designated as verified content 328. Additionally or instead, the content server 110 can modify the submitted content 306 using the content modification module 310 to generate additional verified content 328. The content server 110 can compare the verified content 328 (which can include submitted content 306, modified content 312, or both) to the asset list 127 to determine whether additional digital assets are needed in order to satisfy the content criteria 126. The content server 110 can then use the software package 106 to create generated content 128 that are needed to complete the asset list 127 using the process 200 as illustrated in FIG. 1. The generated content 128 and the verified content 328 can be stored in the content library 112.

In some examples, the content server 110 evaluates the received items (e.g., the software package 106 and the submitted content 306) sequentially by first generating new content 128 using the process 200 as illustrated in FIG. 1, and then evaluating the submitted content 306 using the process 500 as illustrated in FIG. 3. For example, referring to FIG. 1, the content server 110 can use the software package 106 to create generated content 128 using the process 200. The content server 110 can compare the generated content 128 to the asset list 127 to determine whether additional digital assets, or modified digital assets, are needed in order to satisfy the content criteria 126. The content server 110 can then evaluate the submitted content 306 using the content verification module 324 to identify assets within the submitted content 306 that satisfy the content criteria 126 and can therefore be designated as verified content 328. Additionally or instead, the content server 110 can modify the submitted content 306 using the content modification module 310 to generate additional verified content 328. In some examples, the content server 110 can use the content modification module 310 to modify generated content 128 that was generated by the content generation module 124. The generated content 128 and the verified content 328 can be stored in the content library 112.

In some examples, the content server 110 evaluates the received items (e.g., the software package 106 and the submitted content 306) by simultaneously performing the processes 200 and 500. For example, referring to FIG. 1, the content server 110 can emulate the gaming console in order to extract generated content 128 from the simulate game-play of the video game. The content server 110 can simultaneously perform verification and/or modification of the submitted content 306 in order to generate verified content 328. The generated content 128 and the verified content 328 can be stored in the content library 112.

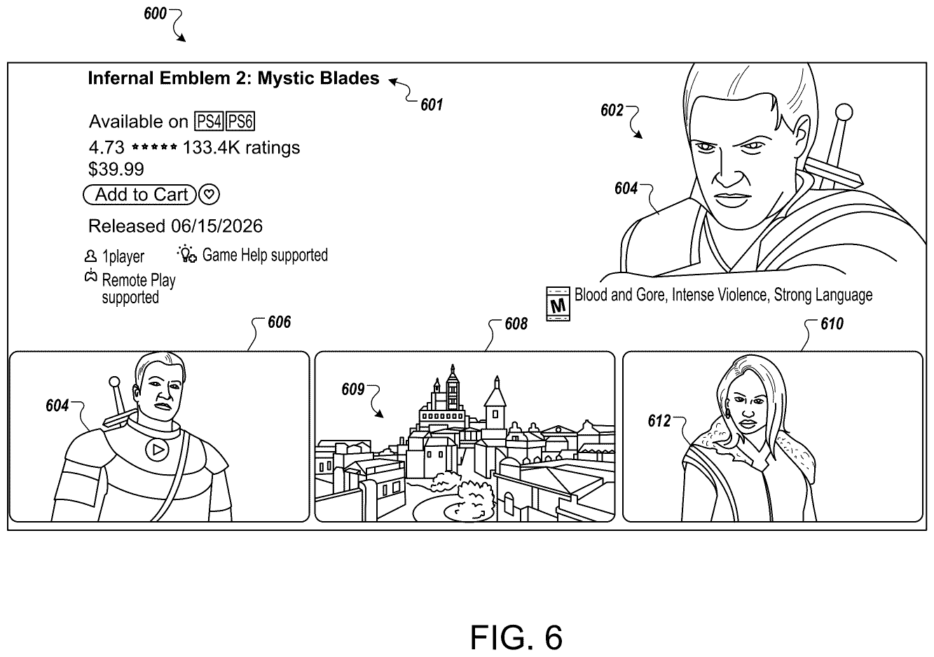

FIG. 6 shows an example game catalog page 600 of a video game. The game catalog page 600 includes digital assets for the video game. The digital assets include a title 601 of the video game. The digital assets include an image 602 of a main character 604. The digital assets include a video 606 of the main character 604. The digital assets include an image 608 of a video game environment 609. The digital assets include an image 610 of a secondary character 612.

The digital assets shown in FIG. 6 are examples of approved content 108 that was generated using the processes shown and described with reference to FIGS. 1 through 5. The digital assets are stored in the game catalog 134 hosted by the gaming platform 130. The game catalog page 600 can be presented to the user 138 on a display of the client device 136 in response to the user 138 selecting the title or logo of the video game on a game index page. The user 138 can interact with the game catalog page 600 in order to view images, videos, and descriptions of the video game. The user 138 can interact with the game catalog page 600 in order to purchase or rent the video game.

FIG. 7 is a diagram illustrating an example of the system 100 approving modified content for publication in a game catalog. The FIG. 7 illustrates a flow of data, shown as stages (A) to (F), with each representing a step in an example process. Stages (A) to (F) can occur in the illustrated sequence, or in a sequence that is different from the illustrated sequence. For example, some of the stages can occur concurrently. The processes shown in FIG. 7 can be performed when the content is required to be approved by an approving authority after modification/generation of the content and before publishing the content to the game catalog 134.

At stage (A), the content server 110 modifies and/or generates (701) content. The content server 110 can generate content using, for example, the processes shown and described with reference to FIGS. 1 and 2. The content server 110 can modify content using, for example, the processes shown and described with reference to FIGS. 3 to 5. The modified and/or generated content is stored as part of the content library 112 in the data repository 111. The content library 112 stores content including digital assets for video games.

At stage (B), after storing the content in the repository, the content server 110 sends, over the network 140, the content for approval 702 by an approving authority. The content server 110 can send the content to the game developer device 102 for approval 702 automatically in response to the modification and/or generation (701) of the content. The approving authority can be, for example, the game developer 104. In some examples, the approving authority is a game owner or game distributor. In some examples, the content is sent for approval by more than one approving authority.

At stage (C), the game developer 104 optionally modifies and/or generates (703) content. For example, the game developer 104 can modify the content that was received at step 702, can generate new content to add to the content that was received at step 702, or both. In some examples, the game developer 104 approves or rejects the content without modifying the content or generating new content.

At stage (D), the content server 110 receives, over the network 140 and from the approving authority, approval or rejection (704) of the content. In some examples, the content includes multiple digital assets, and approving authority approves some of the digital assets while rejecting other of the digital assets. In some cases, the game developer 104 modifies the content at step 703 and sends the modified content to the content server 110 with the approval (704). In some cases, the game developer 104 generates new content at step 703 and sends the new content to the content server 110 with the approval (704).

In response to receiving the approval (704) of a digital asset, the content server, at stage (E), pushes the approved content 108 to the gaming platform 130 for publication in the game catalog 134. When the approval (704) is received along with new or modified content, the content server 110 can perform the verification process as shown and described with reference to FIGS. 3 to 5 before publishing the content.

In response to receiving rejection (704) of a digital asset, the content server 110 can modify the digital asset. For example, the content server 110 can modify the digital asset using the processes shown and described with reference to FIGS. 3 to 5. In some examples, the approving authority (e.g., game developer 104) provides a reason for rejection. The content server 110 can incorporate the approving authority's reason for rejection in the content criteria 126. The content server 110 can then use the content verification module 324 and the content modification module 310 to modify (701) the rejected content to address the reason for rejection.

In an example, the game developer 104 can provide a reason for rejection by stating that the background of the game logo shown in a digital asset is the wrong color, and can specify the correct color. The content server 110 can incorporate the correct color of the background of the game logo into the content criteria 126. The content verification module 324 and content modification module 310 can then modify the digital asset in order to generate a digital asset that shows the correct color for the background of the game logo.

Modifying the digital asset can include changing any combination of: a size of the digital asset, a resolution of the digital asset, relative sizes of images included in the digital asset, a color or color(s) of the digital asset, a layout of the digital asset, a textual content of the digital asset, or another characteristic of the digital asset.

After modifying the digital asset, the content server can send, over the network 140, the digital asset for review by the approving authority. Steps (A) through (D) can repeat until the content server 110 receives approval (704) from the game developer 104. Once approval is obtained by the content server 110, the content server 110 can provide the approved content 108 to the gaming platform 130. In some cases, the content server 110 can automatically provide the approved content 108 to the gaming platform 130 in response to receiving the approval (704). In some examples, the approved content 108 is sent to the gaming platform on-demand when an instruction is received from an administrator following approval (704) of the content. In some examples, the approved content 108 is sent to the gaming platform according to a schedule, such as a schedule for launching the video game.

At stage (F), after the gaming platform 130 receives the approved content 108, a user 138 of the client device 136 can view and interact with the digital assets in the game catalog 134.

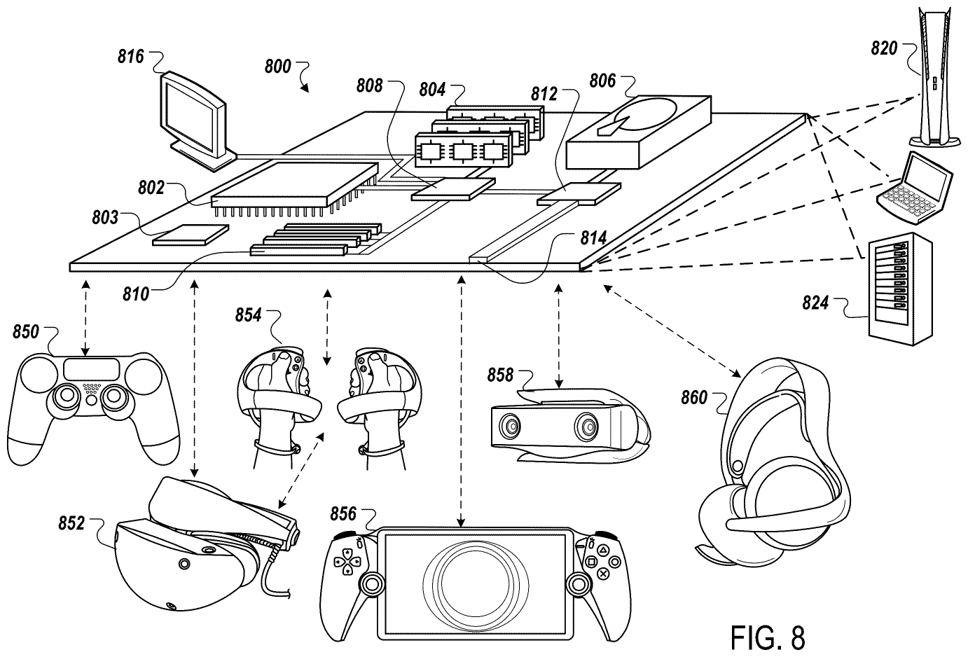

FIG. 8 shows an example of a computing device 800 and associated accessories that can be employed to execute implementations of the present disclosure. The computing device 800 can be a gaming console 820, such as PS5®, PS4®, PS3®, PS2® etc., or as one or more servers 824 or as a rack within a server. In some implementations, the computing device 800 may be implemented as a personal computer such as a laptop computer 822. In some implementations, the computing device 800 can be implemented as a mobile device such as the connected handheld gaming device 856. In some implementations, a computing device can include one or more of the computing device 800, and an entire system may be made up of multiple computing devices communicating with each other. For example, a gaming system can include one or more of a gaming console 820, one or more accessories, and a remote platform such as a cloud-based platform implemented on one or more servers 824. The computing device can also include a desktop computer, a workstation, a personal digital assistant, a server, a blade server, a mainframe, or other appropriate type of computer. The components shown here, their connections and relationships, and their functions, are examples only, and are not limiting. The computing device 800 can form at least a portion of a gaming system (e.g., the gaming platform 130 described above with reference to FIG. 1) that can include one or more remote computing devices such as ones implementing a cloud-based portal or gaming platform.

In various implementations, the computing device 800 includes some combination of one or more processors or central processing units (CPUs) 802, one or more graphic processing units (GPUs) 803, memory 804, one or more storage devices 806, a high-speed interface 808, and/or a low-speed interface 812. In some implementations, the high-speed interface 808 connects to the memory 804 and multiple high-speed expansion ports 810. In certain implementations, the low-speed interface 812 connects to a low-speed expansion port 814 and the storage device 804. In some implementations, the high-speed interface 808 connects to the storage device 804. Each of the processor 802, the GPU 803, the memory 804, the storage device 806, the high-speed interface 808, the high-speed expansion ports 810, and the low-speed interface 812, are interconnected using various buses, and may be mounted on a common motherboard or in other manners as appropriate. The processor 802 can process instructions for execution within the computing device 800, including instructions stored in the memory 804 and/or on the storage device 806 to display graphical information for a graphical user interface (GUI) on an external input/output device, such as a display 816 coupled to the high-speed interface 808. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 804 stores information within the computing device 800. In some implementations, the memory 804 includes a volatile memory unit or units. Alternatively, or in addition, the memory 804 can include a non-volatile memory unit or units. The memory 804 may also include another form of a computer-readable medium, such as a magnetic or optical disk. In some implementations, the memory 804 includes Graphics Double Data Rate (GDDR) memory such as GDDR6 memory configured to provide a unified memory architecture with a high bandwidth. In some implementations, the memory can include high speed memory such as GDDR2, GDDR3, GDDR4, GDDR5, GDDR5X, GDDR6X, GDDR6W or GDDR7. Such high-speed memory can facilitate rapid data access and seamless multitasking, supporting gaming and multimedia applications.

The storage device 806 provides mass storage for the computing device 800. In some implementations, the storage device 806 may be or include a computer-readable medium, such as a hard disk device, an optical disk device, a flash memory, or other similar solid-state memory device, or an array of devices, including devices in a storage area network or other configurations. In some implementations, the storage device 806 can include a high capacity solid-state drive (SSD) configured to support a high throughput (e.g., 5.5 GB/s or more). Such an SSD can facilitate fast load times, enabling near-instantaneous game booting, level transitions, and asset streaming. In some implementations, the storage device 806 can be configured to support expandable storage via compatible non-volatile memory express (NVMe) SSDs. Instructions can be stored in an information carrier, and when executed by one or more processing devices, such as processor 802, perform one or more methods, such as those described above. The instructions can also be stored by one or more storage devices, such as non-transitory computer-readable or machine-readable mediums, such as the memory 804, the storage device 806, or memory on the processor 802. The instructions can constitute software for providing interactive game play on a user interface such as a graphical user interface (GUI) presented on the display 816.

The high-speed interface 808 generally manages bandwidth-intensive operations for the computing device 800, while the low-speed interface 812 generally manages lower bandwidth-intensive operations. Such allocation of functions is an example only. In some implementations, the high-speed interface 808 is coupled to the memory 804, the display 816 (e.g., through a graphics processor or accelerator), and to the high-speed expansion ports 810, which accepts various expansion cards. In the implementation, the low-speed interface 812 is coupled to the storage device 806 and the low-speed expansion port 814. The low-speed expansion port 814, which may include various communication ports (e.g., Universal Serial Bus (USB) Type-A and Type-C ports, High-Definition Multimedia Interface (HDMI) ports, Bluetooth, Ethernet, wireless Ethernet) may be coupled to one or more input/output and/or accessory devices. Such input/output and accessory devices can include a controller 850 such as a DualSense®, DualShock®, or Access™ controllers for PlayStation® devices, a virtual reality (VR) or augmented reality (AR) headset 852 such as the PS VR2 headset, accessory controllers 854 such as PS VR2 Sense™, a handheld gaming device 856 such as PlayStation Portal®, a camera 858, and/or an earphone/headphone set 860 such as the PULSE Elite™ headset or the Pulse Explore™ earbuds. In some implementations, the computing device 800 includes one or more acoustic transducers, and/or is connected to one or more external acoustic transducers such as one or more speakers associated with the display 816.

The processor 802 can be implemented as a chipset of chips that include separate and multiple analog and digital processors. For example, the processor 802 can be a multi-core processor that supports high-speed processing and enables complex computational tasks, real-time physics simulations, and advanced artificial intelligence (AI) capabilities. In one example, the processor 802 includes at least 8 cores, at least 16 threads, and operates at variable frequencies around 3.5 GHz or more. In some implementations, the processor 802 may be a Complex Instruction Set Computers (CISC) processor, a Reduced Instruction Set Computer (RISC) processor, or a Minimal Instruction Set Computer (MISC) processor.

In some implementations, the GPU 803 includes a custom GPU that supports an advanced architecture such as the RDNA 2 architecture developed by AMD. In certain examples, the GPU 803 includes at least 36 compute units running at speeds of 2 GHz or more, and delivers performance of at least 10 teraflops. The GPU 803 can be configured to support high quality graphics rendering. For example, the GPU 803 can be configured to support hardware-accelerated ray tracing for enhanced realism in lighting and reflections, thereby providing a highly immersive gaming experience.

The computing device 800 can be configured to interact with one or more connected input/output or accessory device in providing the gaming experience. In some implementations, the computing device communicates with a handheld controller 850—e.g., a DualSense®, DualShock®, or Access™ controller for PlayStation® devices—to provide the gaming experience. The controller 850 can feature a high-fidelity haptic feedback system with one or more actuators that simulate a wide range of tactile sensations. In some implementations, the controller 850 includes one or more adaptive triggers that adjust resistance based on in-game actions to provide for a realistic feel.

The ergonomic design of the controller 850 can allow for comfortable use even in long gaming sessions. For example, the controller 850 can include textured grips and an optimized button layout. In some implementations, the controller 850 includes one or more of: integrated motion sensors, a high-resolution touchpad, and a built-in microphone array. The controller 850 includes an array of buttons, joysticks, and other controls that allow a user to interact with the computing device 800 to participate in interactive gameplay presented, for example, on a display device such as the display 816. The controller 850 can be powered by one or more regular or rechargeable batteries and supports both wireless and wired connectivity with the computing device 800, for example, via Bluetooth, WiFi, USB-C etc., or via a proprietary connection such as PlayStation Link™. In some implementations, the controller 850 includes a light bar and player indicators for visual feedback and customization.

In some implementations, the input/output or accessory device includes a VR/AR headset 852. One example of such a headset is the PlayStation VR2 (PS VR2) headset that is configured to provide an immersive and interactive gaming experience. In some implementations, the headset 852 features dual displays, e.g., organic light emitting device displays or micro-LED displays, with a combined resolution of 4000 8 2080 pixels or higher—thus providing sharp visuals and a wide field of view.

In some implementations, the VR/AR headset 852 includes eye-tracking technology that enables foveated rendering, by focusing on where the user is looking. In some implementations, the headset 852 includes integrated cameras that facilitate tracking head movements without external sensors. In some implementations, the headset includes haptic feedback for tactile sensations and/or one or more acoustic transducers configured to provide a spatial sound effect the user. The headset 852 can include an adjustable headband and cushioned padding, and can be configured to connect to the computing device 800 either over a wireless network (e.g., over a WiFi® or Bluetooth® connection, or a proprietary connection such as PlayStation Link™) or over a wire such as a USB-C cable.

In some implementations, the headset 852 can be configured to work in conjunction with one or more accessory controllers 854 such as the PlayStation VR2 Sense™ controllers. The accessory controllers 854 can enhance the immersive gaming experience through various features such as advanced haptic feedback for detailed in-game sensations, adaptive triggers with dynamic resistance to simulate real-world actions, and finger touch detection for natural interactions. The ergonomics of the accessory controllers 854 can provide a comfortable experience even during extended gameplay. In some implementations, the accessory controllers include one or more integrated sensors (accelerometer, gyroscope, etc.) and/or cameras to provide motion tracking. The accessory controllers 854 can be configured to connect to the computing device 800 and/or the headset 852 over a wireless connection such as WiFi® or Bluetooth®.

In some implementations, the computing device 800 is connected to a handheld gaming device 856 such as the PlayStation Portal®. The handheld gaming device 856 can be configured to stream games and media from the computing device 800 via a wireless connection such as WiFi® or Bluetooth®. The handheld gaming device 856 includes a high-resolution screen that allows users to play games and/or stream media remotely without using the display 816 connected to the computing device 800. This allows the display to be used for other purposes while the computing device 800 facilitates gameplay on the handheld gaming device 856. In some implementations, the handheld gaming device 856 is configured to act as a streaming receiver without running games natively on the device 856 itself. This makes the handheld gaming device 856 a convenient option for playing games run on the computing device 800, while leaving a TV connected to the computing device 800 free to be used for viewing other media. The handheld gaming device 856 can includes buttons and features similar to (or even same as) the controller 850, thus providing for a similar gaming experience as that with the controller 850.

In some implementations, the input/output or accessory devices includes a camera 858 and/or an earphone/headphone set 860 such as the PULSE Elite™ headset or the Pulse Explore™ earbuds. The camera 858 can be used to track user-movements, which in turn can be used as an input to an interactive game being executed on the computing device 800. The earphone/headphone set 860 can be used to provide audio feedback/output to a user from the computing device 800. In some implementations, the earphone/headphone set 860 can include a microphone to receive spoken inputs/instructions that in turn can be used to control an interactive game being executed on the computing device 800.

While this specification contains many specific implementation details, these should not be construed as limitations on the scope of what is being claimed, which is defined by the claims themselves, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous. Various forms of the flows shown above can be used, with steps re-ordered, added, or removed.

While this specification contains many specifics, these should not be construed as limitations on the scope of the invention or of what can be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

What is claimed is:

1. A computer-implemented method, the method comprising:
obtaining, by one or more processing devices, content criteria for digital assets representative of a video game;
receiving, by the one or more processing devices and over a network, a compressed software package including a plurality of files representing game elements associated with the video game;
decompressing, by the one or more processing devices, the software package to obtain the plurality of files representing the game elements the video game;
emulating, by the one or more processing devices, a gaming console to simulate game-play of the video game using the plurality of files, the game-play using at least a portion of the game elements represented in the plurality of files;
generating, by the one or more processing devices and from the simulated game-play, one or more digital assets that satisfy the content criteria; and
storing, by the one or more processing devices, the one or more digital assets in a repository, wherein the one or more digital assets are configured to provide preview of the video game.

2. The method of claim 1, wherein generating the one or more digital assets comprises:
extracting an image from the simulated game-play of the video game;
determining whether the image satisfies the content criteria; and
in response to determining that the image satisfies the content criteria, storing the image as a digital asset of the one or more digital assets; or
in response to determining that the image does not satisfy the content criteria:
modifying the image such that the modified image satisfies the content criteria; and
storing the modified image as a digital asset of the one or more digital assets.

3. The method of claim 1, wherein the content criteria specifies a list of digital assets to be published for the video game, the method comprising iteratively generating digital assets until the stored one or more digital assets include every item on the list of digital assets.

4. The method of claim 1, wherein the game elements include at least one of: textures, characters, sounds, objects, and models, for the video game.

5. The method of claim 1, further comprising:
identifying the gaming console in accordance with a formatting of the compressed software package.

6. The method of claim 5, the method comprising:
configuring an emulator to emulate the gaming console; and
using the configured emulator to simulate the game-play of the video game.

7. The method of claim 1, wherein generating the one or more digital assets that satisfy the content criteria comprises:
processing the simulated game-play of the video game with a machine learning model that is trained to extract digital assets representative of video games; and
evaluating the extracted digital assets using the content criteria.

8. The method of claim 1, wherein the one or more digital assets each comprise one or more of: an image file, a video file, or a text file.

9. The method of claim 1, comprising:
after storing the one or more digital assets in the repository, sending, over the network, the one or more digital assets for review by an approving authority.

10. The method of claim 9, comprising:
receiving, over the network and from the approving authority, approval of a digital asset of the one or more digital assets; and
publishing the digital asset to a digital video game catalog.

11. The method of claim 9, comprising:
receiving, from the approving authority, rejection of a digital asset of the one or more digital assets;
modifying the digital asset; and
sending, over the network, the modified digital asset for review by the approving authority.

12. The method of claim 11, wherein modifying the digital asset includes changing one or more of:
a size of the digital asset,
a resolution of the digital asset,
relative sizes of images included in the digital asset,
a color of the digital asset,
a layout of the digital asset, or
a textual content of the digital asset.

13. The method of claim 1, wherein:
a digital asset of the one or more digital assets includes an image and metadata describing the image, and
storing the digital asset comprises storing the digital asset in association with the metadata.

14. The method of claim 1, wherein:
generating a digital asset of the one or more digital assets comprises:
extracting an image from the simulated game-play of the video game;
generating a set of metadata describing the image; and
determining whether the image satisfies the content criteria based at least in part on the generated set of metadata,
wherein storing the digital asset comprises storing the digital asset in association with the generated set of metadata.

15. The method of claim 1, wherein generating a digital asset of the one or more digital assets comprises:
providing simulation data from the simulated game-play of the video game to a machine learning model that is trained to recognize digital assets that satisfy the content criteria; and
obtaining the digital assets as output from the machine learning model.

16. A system comprising:
one or more processing devices; and
one or more non-transitory computer-readable media storing instructions that, when executed, cause the one or more processing devices to perform operations comprising:
obtaining content criteria for digital assets representative of a video game;
receiving, over a network, a compressed software package including a plurality of files representing game elements associated with the video game;
decompressing the software package to obtain the plurality of files representing the game elements associated with the video game;
emulating a gaming console to simulate game-play of the video game using the plurality of files, the game-play using at least a portion of the game elements represented in the plurality of files;
generating, from the simulated game-play, one or more digital assets that satisfy the content criteria; and
storing the one or more digital assets in a repository, wherein the one or more digital assets are configured to provide preview of the video game.

17. The system of claim 16, wherein generating the one or more digital assets comprises:
extracting an image from the simulated game-play of the video game;
determining whether the image satisfies the content criteria; and
in response to determining that the image satisfies the content criteria, storing the image as a digital asset of the one or more digital assets; or
in response to determining that the image does not satisfy the content criteria:
modifying the image such that the modified image satisfies the content criteria; and
storing the modified image as a digital asset of the one or more digital assets.

18. The system of claim 16, wherein the content criteria specifies a list of digital assets to be published for the video game, the operations comprising iteratively generating digital assets until the stored one or more digital assets include every item on the list of digital assets.

19. A non-transitory computer-readable medium storing software comprising instructions executable by one or more processing devices which, upon such execution, cause the one or more processing devices to perform operations comprising:
obtaining content criteria for digital assets representative of a video game;
receiving, over a network, a compressed software package including a plurality of files representing game elements associated with the video game;
decompressing the software package to obtain the plurality of files representing the game elements associated with the video game;
emulating a gaming console to simulate game-play of the video game using the plurality of files, the game-play using at least a portion of the game elements represented in the plurality of files;
generating, from the simulated game-play, one or more digital assets that satisfy the content criteria; and
storing the one or more digital assets in a repository, wherein the one or more digital assets are configured to provide preview of the video game.

20. The non-transitory computer-readable medium of claim 19, wherein generating the one or more digital assets comprises:
extracting an image from the simulated game-play of the video game;
determining whether the image satisfies the content criteria; and
in response to determining that the image satisfies the content criteria, storing the image as a digital asset of the one or more digital assets; or
in response to determining that the image does not satisfy the content criteria:
modifying the image such that the modified image satisfies the content criteria; and
storing the modified image as a digital asset of the one or more digital assets.
